(19) United States
(12) Patent Application Publication
(10) Pub. No.: US 2012/0130024 A1
(43) Pub. Date: May 24, 2012

(54) POLYGLYCOLIC ACID-BASED FIBERS AND METHOD FOR PRODUCING SAME

(75) Inventors: Hiroyuki Sato, Tokyo (JP); Masahiro Yamazaki, Tokyo (JP); Ryo Kato, Tokyo (JP); Kotaku Saigusa, Tokyo (JP)

(73) Assignee: KUREHA CORPORATION, Tokyo (JP)

(21) Appl. No.: 13/388,762

(22) PCT Filed: Jul. 14, 2010
(86) PCT No.: PCT/JP2010/061883

§ 371 Date: Feb. 3, 2012

(30) Foreign Application Priority Data
Aug. 6, 2009 (JP) JP2009-183223

(51) Int. Cl. D01F 6/92; C08L 67/04; B29C 47/00

(52) U.S. Cl. 525/450; 264/148

(57) ABSTRACT

A method for producing a polyglycolic acid-based fiber, includes a spinning process of obtaining undrawn yarns by melt spinning a polyglycolic acid-based resin composition, which comprises a polyglycolic acid resin and a polylactic acid resin having a weight average molecular weight of 10×10⁴ to 30×10⁴ in a mass ratio of the polyglycolic acid resin to the polylactic acid resin of 70/30 to 99/1. The method also includes a keeping process of keeping the undrawn yarns and a drawing process of obtaining drawn yarns by drawing the kept undrawn yarns.

### TECHNICAL FIELD

The present invention relates to a polyglycolic acid-based fiber comprising a polyglycolic acid resin and a polylactic acid resin, and a method for producing the same.

### BACKGROUND ART

Fibers (polyglycolic acid fibers) made of polyglycolic acid have been used as fibers having biodegradability and bioabsorbability in various fields such as the medical field. In addition, polyglycolic acid is excellent in heat resistance and mechanical strength. Moreover, polyglycolic acid fibers are expected to be applied for drilling or completion field of oil recovery and the like as fibers exhibiting a fast hydrolyzability under high temperature environments. However, since conventional polyglycolic acid fibers are produced by spin drawn yarn (SDY) method in which the drawing is conducted after spinning without winding, if yarn break or the like occurs during the drawing, a large amount of resin is discharged in the spinning step. Accordingly, the SDY method is inefficient for mass production, and it is not easy to reduce the production costs of polyglycolic acid fibers. For this reason, the applications of polyglycolic acid fibers are limited to those in special and high value added fields, such as surgical sutures.

On the other hand, polyolefin fibers, nylon fibers, polylactic acid fibers, and the like are produced in such a manner that undrawn yarns after spinning are once wound or put in cans to be kept, and then drawn (see, for example, Japanese Unexamined Patent Application Publication No. 2005-350829 (PTL 1), Japanese Unexamined Patent Application Publication No. 2006-22445 (PTL 2), Japanese Unexamined Patent Application Publication No. 2007-70750 (PTL 3), Japanese Unexamined Patent Application Publication No. 2008-174898 (PTL 4), and Japanese Unexamined Patent Application Publication No. 2005-307427 (PTL 5)). In this method, the spun, undrawn yarns can be drawn in a bundle, and the spinning step and the drawing step are each independently conducted, because it is unnecessary to draw yarns immediately after the spinning. Hence, this method achieves a high productivity, and is suitable for mass production.

However, production of a polyglycolic acid fiber in this method involves a problem that undrawn yarns of polyglycolic acid wound or put in cans agglutinate during keeping, and the undrawn yarns are difficult to release, so that the undrawn yarns cannot be drawn. In addition, even if a polyglycolic acid resin composition obtained by compounding a polyglycolic acid and a polylactic acid having a weight average molecular weight of 5×10⁴ or less described in International Publication No, WO 2008/004490 (PTL 6) is used instead of the polyglycolic acid, it is difficult to sufficiently suppress the agglutination of the undrawn yarns during keeping.

### CITATION LIST

### Patent Literature

[PTL 1] Japanese Unexamined Patent Application. Publication No. 2005-350829
[PTL 2] Japanese Unexamined Patent Application Publication No. 2006-22445
[PTL 3] Japanese Unexamined Patent Application Publication No. 2007-70750
[PTL 4] Japanese Unexamined Patent Application Publication No. 2008-174898
[PTL 5] Japanese Unexamined Patent Application Publication No. 2005-307427
[PTL 6] International Publication No. WO 2008/004490

### SUMMARY OF INVENTION

### Technical Problem

The present invention has been made in view of the above-described problems of the conventional technologies, and an object of the present invention is to provide a method for producing a polyglycolic acid-based fiber, in which, even when undrawn polyglycolic acid-based yarns obtained by spinning a resin composition comprising a polyglycolic acid resin are kept for a long time, no agglutination occurs, the undrawn yarns can be released and drawn relatively easily, and moreover characteristics of the polyglycolic acid fiber are not impaired.

### Solution to Problem

The present inventors have conducted earnest study to achieve the above-described object. As a result, the present inventors have found the following facts. Specifically, when undrawn yarns obtained by spinning a resin composition comprising a polyglycolic acid resin and a polylactic acid resin having a low-molecular weight are kept, the polyglycolic acid resin and the polylactic acid resin having a low-molecular weight are prone to undergo a complete or partial ester exchange reaction with each other during melt compounding to thereby form a copolymer, or the polyglycolic acid resin and the polylactic acid resin having a low-molecular weight are prone to be in the state of compatible polymer blend. Hence, although the characteristics of the polyglycolic acid fiber is not substantially impaired, the function of the polylactic acid resin is not exerted sufficiently, so that the glass transition temperature (Tg) of the undrawn yarns decreases with time under a high temperature and a high humidity, and the undrawn yarns shrink. As a result, the agglutination occurs. In this respect, the present inventors have found the following facts. Specifically, when a polyglycolic acid resin and a polylactic acid resin having a relatively high molecular weight are blended with each other, these resins are likely to be in the state of immiscible polymer blend. Hence, the decrease in the glass transition temperature (Tg) attributable to the polyglycolic acid resin in undrawn yarns with time can, be suppressed even under a high temperature and a high humidity, while the characteristics of the polyglycolic acid fiber are maintained. As a result, the shrinkage of the undrawn yarns can be prevented, so that the agglutination can be suppressed. The findings have led to the completion of the present invention.

Specifically, a method for producing a polyglycolic acid-based fiber of the present invention comprises: a spinning process of obtaining undrawn yarns by melt spinning a polyglycolic acid-based resin composition which comprises a polyglycolic acid resin and a polylactic acid resin having a weight average molecular weight of 10×10⁴ to 30×10⁴ in a mass ratio of the polyglycolic acid resin to the polylactic acid resin of 70/30 to 99/1; a keeping process of keeping the undrawn yarns; and a drawing process of obtaining drawn yarns by drawing the kept undrawn yarns.

In the method for producing a polyglycolic acid-based fiber of the present invention, a keeping time in the keeping process is preferably 3 hours or more. Moreover, the method for producing a polyglycolic acid-based fiber of the present invention may further comprise a cutting process of obtaining a staple fiber by cutting the drawn yarns.

A polyglycolic acid-based fiber of the present invention comprises a polyglycolic acid resin and a polylactic acid resin having a weight average molecular weight of 10×10⁴ to 30×10⁴ in a mass ratio of the polyglycolic acid resin to the polylactic acid resin of 70/30 to 99/1.

Note that, in the present invention, the “releasing” of undrawn yarns means that the undrawn yarns are released enough to be drawn, and specifically means that undrawn yarns wound on a bobbin or put in cans are released to a drawable unit (for example, individual yarn). In addition, in the present invention, the drawn yarns and the staple fiber may also be referred to collectively as a “polyglycolic acid-based fiber.” moreover, in this description, the “polyglycolic acid fiber” means a fiber whose resin consists of a polyglycolic acid resin, whereas the “polyglycolic acid-based fiber” means a fiber comprising a polyglycolic acid resin and another resin, such as polylactic acid.

Although it is not exactly clear why the undrawn yarns comprising the polyglycolic acid become difficult to agglutinate in the production method of the present invention, the present inventors speculate as follows. Specifically, a polyglycolic acid resin has higher water absorbability than other polyester resins such as polylactic acid, and is likely to absorb water during the spinning and during the application of an oiling agent to the undrawn yarns. The Tg of the undrawn yarns of the polyglycolic acid thus absorbing water tends to decrease with time during keeping, and the tendency is increased as the keeping temperature is increased. The undrawn yarns whose Tg decreases to around the keeping temperature shrink, and the single yarns are pressure bonded to each other, to agglutinate.

Meanwhile, a polylactic acid resin absorbs a small amount of water during the spinning and during the application of an oiling agent to the undrawn yarns, and the change in Tg with time is less likely to occur. In addition, since a polylactic acid resin has a higher Tg (approximately 55° C.) than that of the polyglycolic acid resin, the shrinkage is less likely to occur even when the keeping temperature is high. Accordingly, as long as the keeping is started at a temperature lower than the Tg of the resin, the shrinkage as described above does not occur, and no agglutination of the undrawn yarns occurs.

However, even in a case where such a polylactic acid resin whose Tg is less likely to decrease is blended with a polyglycolic acid resin, if the molecular weight of the polylactic acid resin is low, the polylactic acid resin having a low-molecular weight and the polyglycolic acid resin are prone to undergo an ester exchange reaction at least in a part or a partial ester exchange reaction during the melt compounding, to thereby form a copolymer. It is presumed that since the function of polylactic acid segments is not exerted sufficiently in the state of the copolymer, the decrease in the Tg of the undrawn yarns cannot be suppressed sufficiently.

On the other hand, it is presumed that, since the resin composition comprising a polyglycolic acid resin and a polylactic acid resin having a relatively high molecular weight are used in the production method of the present invention, these resins are likely to be present in the state of immiscible polymer blend with each other in the undrawn yarns. The Tg attributable to the polyglycolic acid resin and the Tg attributable to the polylactic acid resin are present in such undrawn yarns in the state of immiscible polymer blend with each other. The function of the polylactic acid resin is sufficiently exerted on the Tg attributable to the polyglycolic acid resin in the state of immiscible polymer blend, and the decrease in the Tg attributable to the polyglycolic acid resin with time is suppressed. It is presumed that, as a result of this, the shrinkage of the undrawn yarns is suppressed, and the agglutination becomes difficult to occur. In addition, it is presumed that, since the polyglycolic acid resin and the polylactic acid resin present in the state of immiscible polymer blend can fully exhibit their respective characteristics, the characteristics of the polyglycolic acid fiber are also maintained in the production method of the present invention.

### Advantageous Effects of Invention

The present invention makes it possible to keep undrawn polyglycolic acid resin-based yarns obtained by spinning a resin composition comprising a polyglycolic acid resin and a polylactic acid resin for a long time without causing agglutination, and to release and draw the kept undrawn yarns relatively easily. Thus, a polyglycolic acid-based fiber having characteristics of a polyglycolic acid fiber can be obtained.

### BRIEF DESCRIPTION OF DRAWINGS

FIG. 1 is a schematic diagram showing a melt spinning apparatus used in Examples and Comparative Examples.

FIG. 2 is a schematic diagram showing a drawing apparatus used in Examples and Comparative Examples.

### DESCRIPTION OF EMBODIMENTS

Hereinafter, the present invention will be described in detail on the basis of preferred embodiments thereof.

A method for producing a polyglycolic acid-based fiber of the present invention comprises; a spinning process of obtaining undrawn yarns by melt spinning a polyglycolic acid-based resin composition which comprises a polyglycolic acid resin and a polylactic acid resin having a predetermined molecular weight in a predetermined mass ratio; a keeping process of keeping the undrawn yarns; and a drawing process of obtaining drawn yarns by drawing the kept undrawn yarns. Note that “polyglycolic acid” is abbreviated as “PGA,” and “polylactic acid” is abbreviated as “PLA,” in the following description.

First, the PGA resin used in the present invention will be described. The PGA resin is a homopolymer of glycolic acid (including a ring-opening polymer of glycolide, which is a cyclic ester derived from two molecules of glycolic acid) constituted of only a glycolic acid repeating unit represented by the following formula (I);

—[O—CH₂—C(═O)]— (1).

Examples of a catalyst used when the PGA resin is produced by ring-opening polymerization of glycolide include known ring-opening polymerization catalysts including tin-based compounds such as tin halides and organic tin carboxylates; titanium-based compounds such as alkoxy titanates; aluminum-based compounds such as alkoxy aluminums; zirconium-based compounds such as zirconium acetylacetonate; and antimony-based compounds such as antimony halide and antimony oxides.

The PGA resin can be produced by a known polymerization method. A temperature for the polymerization is preferably 120 to 300° C., more preferably 130 to 250° C., and particularly preferably 140 to 220° C. If the polymerization temperature is lower than the lower limit, the polymerization tends to proceed insufficiently. Meanwhile, if the polymerization temperature exceeds the upper limit, the produced resin tends to be thermally decomposed.

Meanwhile, a time for the polymerization of the PGA resin is preferably 2 minutes to 50 hours, more preferably 3 minutes to 30 hours, and particularly preferably 5 minutes to 18 hours. If the polymerization time is less than the lower limit, the polymerization tends to proceed insufficiently. Meanwhile, if the polymerization time exceeds the upper limit, the produced resin tends to be too colored.

The PGA resin has a weight average molecular weight of preferably 5×10⁴ to 80×10⁴, and more preferably 8×10⁴ to 50×10⁴. If the weight average molecular weight of the PGA resin is less than the lower limit, the mechanical strength of the PGA-based fiber tends to be low, and the fiber tends to be easily broken. Meanwhile, if the weight average molecular weight exceeds the upper limit, the melt viscosity tends to be high, and the spinning of the PGA-based fiber tends to be difficult. Note that the weight average molecular weight is determined by gel permeation chromatography (GPC) relative to polymethyl methacrylate.

In addition, the PGA resin has a melt viscosity (temperature: 240° C.; shear rate: 122 sec⁻¹) of preferably 1 to 10000 Pa·s, more preferably 100 to 6000 Pa·s, and particularly preferably 300 to 4000 Pa·. If the melt viscosity is less than the lower limit, the mechanical strength of the PGA-based fiber tends to be low, and the fiber tends to be easily broken. Meanwhile, if the melt viscosity exceeds the upper limit, the spinning of the PGA-based fiber tends to be difficult.

Next, the PLA resin used in the present invention will be described. Examples of the PLA resin include a homopolymer of D-lactic acid (including a ring-opening polymer of D-lactide, which is a cyclic ester derived from two molecules of D-lactic acid), a homopolymer of L-lactic acid (including a ring-opening polymer of L-lactide, which is a cyclic eater derived from two molecules of L-lactic acid), a copolymer of D-lactic acid and L-lactic acid (including a ring-opening polymer of D/L-lactide, which is a cyclic ester derived from two molecules of L-lactic acid and L-lactic acid), and mixtures thereof.

Of these PLA resins, one having a weight average molecular weight of 10×10⁴ to 30×10⁴ is used in the present invention. When the weight average molecular weight of the PLA resin falls within the above-described range, the PLA resin and the PGA resin is likely to be in the state of immiscible polymer blend in a case where the PLA resin is blended with the PGA resin. Undrawn PGA-based yarns formed from such a blend have a sea-island structure. Hence, a function of the PLA resin is exerted to suppress the decrease in the Tg attributable to the PGA resin with time, so that the agglutination of the undrawn PGA-based yarns can be prevented, while characteristics of a PGA fiber, such as high hydrolyzability, are maintained. As a result, a PGA-based fiber having characteristics of a PGA fiber, such as a high hydrolyzability, can be obtained. Note that the weight average molecular weight is determined by gel permeation chromatography (GPC) relative to polymethyl methacrylate. The fact that the PGA resin and the PLA resin are in the state of immiscible polymer blend in a resin composition or a fiber comprising the PGA resin and the PLA resin can be verified by the fact that two peaks corresponding to glass transition temperatures are generally observed in differential scanning calorimetry. In the resin composition or the fiber used in the present invention, a lower glass transition temperature Tg^{L} is a Tg attributable to the PGA resin, whereas a higher glass transition temperature Tg^{H} is a Tg attributable to the PLA resin. In addition, when the PGA resin and the PLA resin undergo ester exchange reaction, a spectrum attributable to the ester exchange reaction is observed in an NMR measurement, and an ester exchange reaction ratio can be calculated therefrom. When a PLA resin having a relatively high molecular weight is blended as in the case of the present invention, no spectrum attributable to the ester exchange reaction is observed, and the ester exchange reaction ratio is low. On the other hand, when a PLA resin having a low-molecular weight is blended, a spectrum attributable to the ester exchange reaction is observed, and the ester exchange reaction ratio is high.

If the weight average molecular weight of the PLA resin is less than the lower limit, the PLA resin is prone to undergo a complete or partial ester exchange reaction with the PGA resin to form a copolymer. Hence, although characteristics of the PGA fiber are maintained, the function of the PLA resin is exerted insufficiently. As a result, in the undrawn PGA-based yarns, it is difficult to sufficiently suppress the decrease in Tg attributable to the PGA resin with time during keeping. On the other hand, if the weight average molecular weight of the PLA resin exceeds the upper limit, the melt viscosity is excessively increased, resulting in unstable spinning. Note that the method for polymerizing the PLA resin is not particularly limited, and a known method can be employed.

In addition, the PLA resin has a melt viscosity (temperature: 240° C.; shear rates 122 sec⁻¹) of preferably 1 to 10000 Pa·, more preferably 100 to 6000 Pa·, and particularly preferably 300 to 4000 Pa·s. If the melt viscosity is less than the lower limit, the mechanical strength of the PGA-based fiber tends to be low, and the fiber tends to be easily broken. Meanwhile, if the melt viscosity exceeds the upper limit, the spinning of the PGA-based fiber tends to be difficult.

Next, a PGA-based resin composition used in the present invention will be described. The PGA-based resin composition comprises the PGA resin and the PLA resin in a predetermined mass ratio. The mass ratio (PGA/PLA ratio) between the PGA resin and the PLA resin in the PGA-based resin composition is 70/30 to 99/1. If the PGA/PLA ratio is less than the lower limit, the characteristics of the PGA fiber are not maintained in the undrawn PGA-based yarns, e.g. the hydrolyzability and the spin ability deteriorate, whereas the function of the PLA resin is sufficiently exerted in the undrawn PGA-based yarns, so that the decrease in the Tg attributable to the PGA resin with time is suppressed. Meanwhile, if the PGA/PLA ratio exceeds the upper limit, although the characteristics of the PGA fiber are maintained, the function of the PLA resin is not sufficiently exerted, so that the Tg attributable to the PGA resin in the undrawn PGA-based yarns decreases with time during keeping, making it difficult to sufficiently prevent the agglutination of the undrawn yarns. In addition, the PGA/PLA ratio is preferably 80/20 to 95/5. If the PGA/PLA ratio is less than the lower limit, it tends to be difficult to perform stable spinning. Meanwhile, if the PGA/PLA ratio exceeds the upper limit, it tends to be difficult to sufficiently prevent the agglutination of undrawn PGA-based yarns during keeping under high temperature and high humidity.

In the production method of the present invention, the PGA-based resin composition may be used as it is, or, if necessary, various additives such as a thermal stabilizer, an end-capping agent, a plasticizer, and an ultraviolet absorber, and another thermoplastic resin, may be added to the PGA-based resin composition.

In the method for producing a PGA-based fiber of the present invention, undrawn PGA-based yarns comprising the PGA resin and the PLA resin having a predetermined molecular weight at a predetermined mass ratio are obtained by first melting the PGA-based resin composition and subsequently spinning the melted PGA-based resin composition (a spinning process). A known method can be employed as such a melt spinning method.

In the production method of the present invention, a temperature for the melting of the PGA-based resin composition is preferably 230 to 300° C., and more preferably 250 to 280° C. If the temperature for the melting of the PGA-based resin composition is lower than the lower limit, the extrusion flowability of the PGA-based resin composition tends to be low, so that the spinning thereof tends to be difficult. Meanwhile, if the temperature exceeds the upper limit, the PGA-based resin composition tends to be too colored, or thermally decomposed.

Examples of the method for obtaining undrawn yarns by spinning the melted PGA-based resin composition include known methods such as a method in which the melted PGA-based resin composition is formed in the shape of a yarn by being discharged through a spinning nozzle, and then solidified by cooling. The spinning nozzle is not particularly limited, but a known spinning nozzle can be used. The number of the holes of the nozzle, and the diameters of the holes are not particularly limited. Moreover, a method for the cooling is not particularly limited, but air cooling is preferable because of the simplicity and convenience.

Next, the thus obtained undrawn PGA-based yarns are taken up by a roller or the like, and kept (a keeping process). After the PGA-based resin composition is spun, the obtained undrawn yarns are kept, as described above, and then drawn in a bundled state, whereby the production efficiency of the PGA-based fiber can be improved, so that the PGA-based fiber can be produced at low costs.

A method for keeping the undrawn PGA-based yarns is not particularly limited. Examples of the method include a method in which the taken-up undrawn PGA-based yarns are kept after wound on a bobbin or the like, or after put in cans or the like. The take-up speed (the peripheral speed of the roller) is preferably 100 to 4000 m/min, and more preferably 1000 to 2000 m/min. If the take-up speed is less than the lower limit, the PGA resin tends to be crystallized, making it difficult to draw the undrawn yarns. Meanwhile, if the take-up speed exceeds the upper limit, partial orientation and crystallization tend to proceed, so that the draw ratio tends to be low, and also the strength tends to be low.

In addition, in the production method of the present invention, the undrawn PGA-based yarns after the solidification by cooling may be directly taken up as described above. However, in order to improve the releasing property during drawing, an oiling agent for fiber is preferably applied to the undrawn PGA-based yarns, before the undrawn PGA-based yarns are taken up by a roller or the like.

A temperature for keeping of the undrawn PGA-based yarns is not particularly limited. According to the production method of the present invention, the undrawn PGA-based yarns can be kept stably at 20 to 40° C. If the undrawn PGA-based yarns are kept at a temperature lower than the lower limit, cooling equipment is necessary. Hence, such a temperature is not preferable from the economical viewpoint on industry. Meanwhile, if the undrawn PGA-based yarns are kept at a temperature exceeding the upper limit, the decrease in the Tg attributable to the PGA resin in the undrawn. PGA-based yarns with time occurs for a short time and the agglutination of the undrawn PGA-based yarns may occur in some cases. Hence, such a temperature is not preferable.

In the production method of the present invention, the keeping time of the undrawn PGA-based yarns is not particularly limited, as long as the Tg (ordinarily Tg^{L}) attributable to the PGA resin in the undrawn PGA-based yarns is maintained at preferably 35° C. or above, and more preferably 37° C. or above. That is, it is possible to keep the undrawn PGA-based yarns for a long time. If the Tg (ordinarily Tg^{L}) attributable to the PGA resin in the undrawn PGA-based yarns is lower than the lower limit, the agglutination due to shrinkage tends to occur.

Since a PGA-based resin composition having a mass ratio of the PGA resin to the PLA resin of 99/1 or less (preferably 95/5 or less) is used in the production method of the present invention, for example, even under an environment of a temperature of 40° C. and a humidity of 90% RH, the Tg attributable to the PGA resin in the undrawn PGA-based yarns can be maintained at preferably 35° C. or above (more preferably 37° C. or above) for 3 hours or more (preferably 6 hours or more). Accordingly, the production method of the present invention makes it possible to keep the undrawn PGA-based yarns stably for 3 hours or more (preferably 6 hours or more), facilitating adjustment of production schedule.

On the other hand, when a PGA-based resin composition whose mass ratio of the PGA resin to the PLA resin exceeds the upper limit is used, the decrease in the Tg attributable to the PGA resin in the undrawn PGA-based yarns with time is so remarkable, even under an environment of a temperature of 30° C. and a humidity of 90% RH, that the Tg attributable to the PGA resin decreases to lower than 35° C. after keeping for 2 hours. For this reason, the undrawn PGA-based yarns need to be drawn within 2 hours after the spinning, so that the production schedule tends to be limited.

Next, the thus kept undrawn PGA-based yarns are taken out, while being released, and then are drawn to thereby obtain drawn PGA-based yarns (drawing process). In the present invention, the drawing temperature and the draw ratio are not particularly limited, but can be set appropriately depending on the desired physical properties and the like of the PGA-based fiber. For example, the drawing temperature is preferably 40 to 120° C., and the draw ratio is preferably 2.0 to 6.0.

The thus obtained drawn PGA-based yarns may be directly used as continuous fibers, or may be out into a staple fiber (cutting process). The cutting method is not particularly limited, but a known cutting method for producing a staple fiber can be employed.

The PGA-based fiber of the present invention comprises the PGA resin and the PLA resin having a weight average molecular weight of 10×10⁴ to 30×10⁴. As described above, a PGA-based fiber comprising the PLA resin whose weight average molecular weight is less than the lower limit is difficult to produce, because the decrease in the Tg (ordinarily Tg^{L}) attributable to the PGA resin with time occurs during keeping of the undrawn PGA-based yarns, so that the agglutination occurs. Meanwhile, a PGA-based fiber comprising a PLA resin whose weight average molecular weight exceeds the upper limit is difficult to produce, because the melt viscosity of the PLA resin is high, so that the PGA-based fiber cannot be spun stably.

In addition, in the PGA-based fiber of the present invention, the mass ratio (PGA/PLA ratio) of the PGA resin to the PLA resin is 70/30 to 99/1. If the PGA/PLA ratio is less than the lower limit, characteristics of the PGA fiber are not maintained, e.g., the hydrolyzability and the spin ability deteriorate. Meanwhile, a PGA-based fiber comprising the PGA resin and the PLA resin in a mass ratio exceeding the upper limit is difficult to produce, because the decrease in the Tg attributable to the PGA resin with time occurs during keeping of the undrawn PGA-based yarns, so that the agglutination occurs. Moreover, the PGA/PLA ratio is preferably 80/20 to 95/5. A PGA-based fiber comprising the PGA resin and the PLA resin in a mass ratio less than the lower limit tends to be difficult to produce, because such a PGA-based fiber is difficult to spin stably. Meanwhile, a PGA-based fiber comprising the PGA resin and the PLA resin in a mass ratio exceeding the upper limit tends to be difficult to produce, because the agglutination of the undrawn PGA-based yarns cannot be prevented sufficiently during keeping under a high temperature and a high humidity.

Such a PGA-based fiber can be produced by the above-described method for producing a PGA-based fiber of the present invention. In addition, if necessary, various additives such as a thermal stabilizer, an end-capping agent, a plasticizer, and an ultraviolet absorber, and another thermoplastic resins, may be added to the PGA-based fiber of the present invention.

### EXAMPLES

Hereinafter, the present invention will be described more specifically on the basis of Examples and Comparative Examples. However, the present invention is not limited to Examples below.

### Example 1

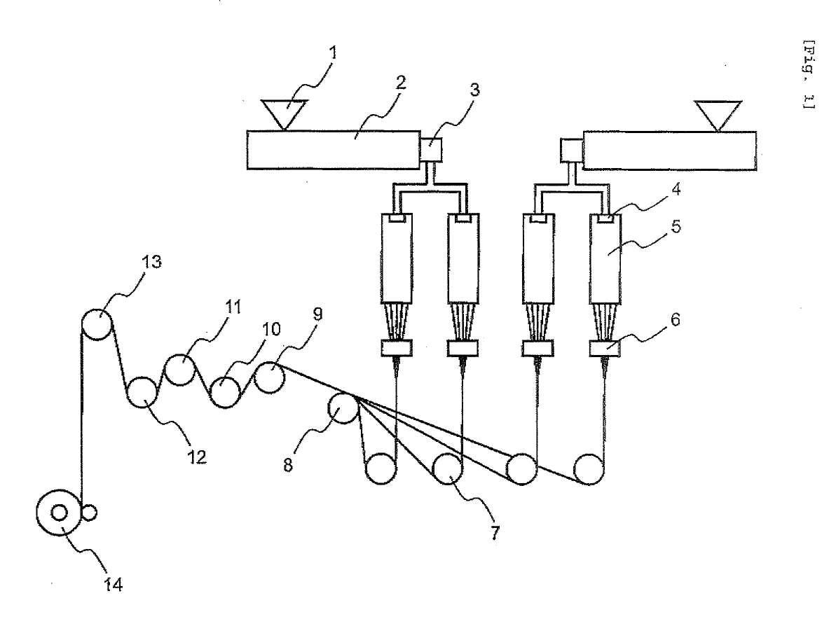

Undrawn PGA/PLA yarns were prepared by using a melt spinning machine shown in FIG. 1. Note that, in the following descriptions and drawings, the same or corresponding components are denoted by the same reference signs, and overlapping descriptions therefor are omitted.

First, a PGA/PLA resin composition (a pellet blend) was prepared by blending a pelletized PGA resin (manufactured by Kureha Corporation; weight average molecular weight Mw: 20×10⁴; melt viscosity (at a temperature of 240° C. and a shear rate of 122 sec⁻¹): 700 Pa·s; glass transition temperature: 43° C.; melting point: 220° C.; size: 3 mm in diameter×3 mm in length) with a pelletized PLA resin (manufactured by NatureWorks LLC; weight average molecular weight Mw: 20×10⁴; melt viscosity (at a temperature of 240° C. and a shear rate of 122 sec⁻¹): 700 Pa·s; glass transition temperature: 57° C.; melting point: 165° C.; size: 3 mm in diameter×3 mm in length) at PGA/PLA=95/5 (mass ratio).

The PGA/PLA resin composition was fed into single screw extruders 2 having a cylinder diameter of 30 mm through raw material hoppers 1, and was melted at 240 to 255° C. Here, the cylinder temperature of the extruders 2 was set to 240 to 255° C., and the head temperature, the gear pump temperature, and the spin pack temperature were set to 255° C.

The melted PGA/PLA resin composition was discharged through 24-hole nozzles 4 (hole diameter: 0.30 mm) at a rate of 0.51 g/min per one by use of gear pumps 3, and solidified into the form of yarns by cooling the discharged composition in cooling towers 5 with air (at approximately 5° C.) An oiling agent for fiber (a surfactant “Delion F-168” manufactured by Takemoto Oil & Fat Co., Ltd,) was applied onto the undrawn PGA/PLA yarns. Then, the undrawn PGA/PLA yarns were taken up by first take-up rollers 7 operated at a peripheral speed of 1000 m/min. Then, through second to seventh take-up rollers 8 to 13, the undrawn PGA/PLA yarns having a single yarn fineness of 4 to 5 denier were wound on a bobbin 14 at 1000 meters per bobbin.

The bobbin on which the undrawn PGA/PLA yarns were wound was placed in a constant temperature and humidity chamber (“HPAV-120-20” manufactured by ISUZU), and was kept therein at a temperature of 30° C. or 40° C. and at a relative humidity of 90% RH for a predetermined time. Before and after keeping, the undrawn PGA/PLA yarns were measured for Tg, and evaluated in terms of the releasing property (whether or not the agglutination occurred), by the following methods. Table 1 shows the results.

<Glass Transition Temperature (Tg)>

In aluminum pan having a capacity of 160 μl, 10 mg of the undrawn PGA/PLA yarns were weighted, and mounted on a differential scanning calorimeter (“DSC-15” manufactured by Mettler Toledo International Inc.). Then, the undrawn PGA/PLA yarns were heated from −50° C. to 280° C. at 20° C./min, and then cooled form 280° C. to 50° C. at 20° C./min. The glass transition temperature of the undrawn PGA/PLA yarns was determined from an exothermic peak(s) obtained during the cooling. When two exothermic peaks corresponding to glass transition temperatures were detected in this case, the higher glass transition temperature was denoted by Tg^{H} (unit: ° C.), whereas the lower glass transition temperature was denoted by Tg^{L} (unit: ° C.). Meanwhile, when only one exothermic peak corresponding to a glass transition temperature was detected, the glass transition temperature was denoted simply by Tg (unit: ° C.).

<Releasing Property of Undrawn Yarns>

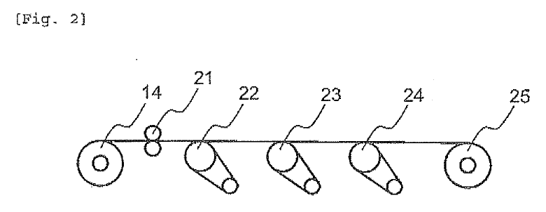

The bobbin on which the undrawn PGA/PLA yarns were wound was mounted on a drawing apparatus shown in FIG. 2. The undrawn. PGA/PLA yarns were released, and taken out from the bobbin 14 through feeding rollers 21 by a first heating roller 22 operated at a temperature of 60° C. and a peripheral speed of 900 m/min. Then, the undrawn PGA/PLA yarns were wound on a bobbin 25 through a second heating roller 23 operated at a temperature of 85° C. and a peripheral speed of 1.800 m/min and through a cooling roller 24. Thus, drawn PGA/PLA yarns were obtained. The releasing property of the undrawn PGA/PLA yarns at this time was evaluated on the basis of the following criteria.

A: No agglutination was observed, and the releasing property was uniform and good.
B: Although no agglutination was observed, the releasing property was partially lacking in uniformity.
C: Agglutination occurred, and the undrawn yarns were difficult to release.

In addition, the hydrolyzability of the drawn PGA/PLA yarns obtained in the test for the releasing property of the undrawn PGA/PLA yarns was evaluated by the following method. Table 1 shows the results.

<Hydrolyzability of Drawn Yarns>

In boiling water of 90° C., 1 g of the drawn PGA/PLA yarns were immersed for 12 hours, and then the hydrolyzability of the drawn PGA/PLA yarns was evaluated on the basis of the following criteria.

A: The drawn PGA/PLA yarns were degraded, and no shape of the fiber remained (good hydrolyzability).
B: The shape of the fiber remained (poor hydrolyzability).

### Examples 2 to 4

Undrawn PGA/PLA yarns were prepared and kept for a predetermined period in the same manner as in Example 1, except that the mixing ratios of the PGA to the PLA were changed to PGA/PLA=90/10, 80/20, and 75/25, respectively. Before and after keeping, the undrawn PGA/PLA yarns were measured for Tg, and evaluated in terms of the releasing property (whether or not the agglutination occurred), in the same manner as in Example 1. In addition, the hydrolyzability of the drawn PGA/PLA yarns was also evaluated in the same manner as in Example 1. Tables 1 and 2 show these results.

### Comparative Example 1

Undrawn WGA/PLA yarns were prepared and kept for a predetermined period in the same manner as in Example 2, except that a PLA resin having a weight average molecular weight Mw of 52000 described in International Publication No. WO 2008/004490 was melt blended for use in place of the PLA resin having a weight average molecular weight Mw of 20×10⁴. Before and after keeping, the undrawn PGA/PLA yarns were measured for Tg, and evaluated in terms of the releasing property (whether or not the agglutination occurred), in the same manner as in Example 1. In addition, the hydrolyzability of the drawn PGA/PLA yarns was evaluated in the same manner as in Example 1. Table 3 shows these results.

### Comparative Example 2

Undrawn PGA yarns were prepared and kept for a predetermined period in the same manner as in Example 1, except that the pelletized PGA resin described in Example 1 was used in place of the PGA/PLA resin composition. Before and after keeping, the undrawn PGA yarns were measured for Tg, and evaluated in terms of the releasing property (whether or not the agglutination occurred), in the same manner as in Example 1. In addition, the hydrolyzability of the drawn PGA yarns was evaluated in the same manner as in Example 1. Table 3 shows these results.

### Comparative Example 3

Undrawn PLA yarns were prepared and kept for a predetermined period in the same manner as in Example 1, except that the pelletized PLA resin described in Example 1 was used in place of the PGA/PLA resin composition. Before and after keeping, the undrawn PLA yarns were measured for Tg, and evaluated in terms of the releasing property (whether or not the agglutination occurred), in the same manner as in Example 1. In addition, the hydrolyzability of the drawn PLA yarns was evaluated in the same manner as in Example 1. Table 4 shows these results.

### Comparative Example 4

Glycolic acid and lactic acid were mixed with each other in a mass ratio of 90/10, and 0.003 parts by mass of tin chloride dihydrate was added as a catalyst to 100 parts by mass of the mixture. The mixture was polymerized by heating at 170° C. for 24 hours. Thus, a glycolic acid-lactic acid Copolymer (hereinafter abbreviated as a “PGLLA copolymer”) was prepared, which was then pelletized. The PGLLA copolymer had a weight average molecular weight Mw of 20×10⁴, a melt viscosity (temperature 240° C., shear rate 122 sec⁻¹) of 700 Paws, a glass transition temperature of 40° C., and a melting point of 200° C.

Undrawn PGLLA yarns were prepared and kept for a predetermined period in the same manner as in Example 1, except that this pelletized PGLLA copolymer was used in place of the PGA/PLA resin composition. Before and after keeping, the undrawn. PGLLA yarns were measured for Tg, and evaluated in terms of the releasing property (whether or not the agglutination occurred), in the same manner as in Example 1. In addition, the hydrolyzability of the drawn PGLLA yarns was evaluated in the same manner as in Example 1. Table 4 shows these results.

### Comparative Example 5

Undrawn PGA/PLA yarns were prepared and kept for a predetermined period in the same manner as in Example 1, except that the mixing ratio of PGA to PLA was changed to PGA/PLA=60/40. Before and after keeping, the undrawn PGA/PLA yarns were measured for Tg, and evaluated in terms of the releasing property (whether or not the agglutination occurred), in the same manner as in Example 1. In addition, the hydrolyzability of the'drawn PGA/PLA yarns was evaluated in the same manner as in Example 1. Table 5 shows these results.

TABLE 1

| | | Example 1 | | | | | |
|---|---|---|---|---|---|---|---|
| | | PLA molecular weight Mw = 20 × 10⁴ | | | | | |
| | | PGA/PLA (mass ratio) 95/5 | | | | | |
| | | Keeping conditions | | | | | |
| | | 30° C., 90% RH | | | 40° C., 90% RH | | |
| | | Tg | Releasing | Degrad- | Tg | Releasing | Degrad- |
| | | (° C.) | property | ability | (° C.) | property | ability |
| Keeping | 0 | 40 | A | A | 40 | A | A |
| time | 1 | 37 | A | A | 37 | A | A |
| (hr) | 3 | 35 | A | A | 35 | A | A |
| | 6 | 34 | A | A | 34 | B | A |
| | 18 | 34 | B | A | 32 | B | A |

| | | Example 2 | | | | | | | |
|---|---|---|---|---|---|---|---|---|---|
| | | PLA molecular weight Mw = 20 × 10⁴ | | | | | | | |
| | | PGA/PLA (mass ratio) 90/10 | | | | | | | |
| | | Keeping conditions | | | | | | | |
| | | 30° C., 90% RH | | | | 40° C., 90% RH | | | |
| | | Tg^{L} | Tg^{H} | Releasing | Degrad- | Tg^{L} | Tg^{H} | Releasing | Degrad- |
| | | (° C.) | (° C.) | property | ability | (° C.) | (° C.) | property | ability |
| Keeping | 0 | 38 | 57 | A | A | 38 | 57 | A | A |
| time | 1 | 37 | 57 | A | A | 37 | 57 | A | A |
| (hr) | 3 | 38 | 57 | A | A | 38 | 57 | A | A |
| | 6 | 37 | 57 | A | A | 37 | 57 | A | A |
| | 18 | 37 | 57 | A | A | 37 | 57 | A | A |

TABLE 2

| | | Example 3 | | | | | | | |
|---|---|---|---|---|---|---|---|---|---|
| | | PLA molecular weight Mw = 20 × 10⁴ | | | | | | | |
| | | PGA/PLA (mass ratio) 80/20 | | | | | | | |
| | | Keeping conditions | | | | | | | |
| | | 30° C., 90% RH | | | | 40° C., 90% RH | | | |
| | | Tg^{L} | Tg^{H} | Releasing | Degrad- | Tg^{L} | Tg^{H} | Releasing | Degrad- |
| | | (° C.) | (° C.) | property | ability | (° C.) | (° C.) | property | ability |
| Keeping | 0 | 38 | 57 | A | A | 38 | 57 | A | A |
| time | 1 | 38 | 57 | A | A | 37 | 57 | A | A |
| (hr) | 3 | 36 | 57 | A | A | 36 | 57 | A | A |
| | 6 | 37 | 57 | A | A | 33 | 57 | A | A |
| | 18 | 37 | 57 | A | A | 32 | 57 | A | A |

| | | Example 4 | | | | | | | |
|---|---|---|---|---|---|---|---|---|---|
| | | PLA molecular weight Mw = 20 × 10⁴ | | | | | | | |
| | | PGA/PLA (mass ratio) 75/25 | | | | | | | |
| | | Keeping conditions | | | | | | | |
| | | 30° C., 90% RH | | | | 40° C., 90% RH | | | |
| | | Tg^{L} | Tg^{H} | Releasing | Degrad- | Tg^{L} | Tg^{H} | Releasing | Degrad- |
| | | (° C.) | (° C.) | property | ability | (° C.) | (° C.) | property | ability |
| Keeping | 0 | 38 | 57 | A | A | 38 | 57 | A | A |
| time | 1 | 38 | 57 | A | A | 35 | 57 | A | A |
| (hr) | 3 | 38 | 57 | A | A | 35 | 57 | A | A |
| | 6 | 37 | 57 | A | A | 36 | 57 | A | A |
| | 18 | 37 | 57 | A | A | 33 | 57 | A | A |

TABLE 3

| | | Comparative Example 1 | | | | | |
|---|---|---|---|---|---|---|---|
| | | PLA molecular weight Mw = 5.2 × 10⁴ | | | | | |
| | | PGA/PLA (mass ratio) 90/10 | | | | | |
| | | Keeping conditions | | | | | |
| | | 30° C., 90% RH | | | 40° C., 90% RH | | |
| | | Tg | Releasing | Degrad- | Tg | Releasing | Degrad- |
| | | (° C.) | property | ability | (° C.) | property | ability |
| Keeping | 0 | 40 | A | A | 40 | A | A |
| time | 1 | 38 | A | A | 34 | C | A |
| (hr) | 3 | 37 | A | A | 30 | C | A |
| | 6 | 33 | C | A | 27 | C | A |
| | 18 | 25 | C | A | 25 | C | A |
| | | Comparative Example 2 | | | | | |
| | | PLA molecular weight Mw = 20 × 10⁴ | | | | | |
| | | PGA/PLA (mass ratio) 100/0 | | | | | |
| | | Keeping conditions | | | | | |
| | | 30° C., 90% RH | | | 40° C., 90% RH | | |
| | | Tg | Releasing | Degrad- | Tg | Releasing | Degrad- |
| | | (° C.) | property | ability | (° C.) | property | ability |
| Keeping | 0 | 40 | A | A | 40 | A | A |
| time | 1 | 38 | A | A | 33 | C | A |
| (hr) | 3 | 33 | C | A | 27 | C | A |
| | 6 | 34 | C | A | 25 | C | A |
| | 18 | 27 | C | A | 23 | C | A |

TABLE 4

| | | Comparative Example 3 | | | | | |
|---|---|---|---|---|---|---|---|
| | | PLA molecular weight Mw = 20 × 10⁴ | | | | | |
| | | PGA/PLA (mass ratio) 0/100 | | | | | |
| | | Keeping conditions | | | | | |
| | | 30° C., 90% RH | | | 40° C., 90% RH | | |
| | | Tg | Releasing | Degrad- | Tg | Releasing | Degrad- |
| | | (° C.) | property | ability | (° C.) | property | ability |
| Keeping | 0 | 57 | A | B | 57 | A | B |
| time | 1 | 57 | A | B | 57 | A | B |
| (hr) | 3 | 57 | A | B | 57 | A | B |
| | 6 | 57 | A | B | 56 | A | B |
| | 18 | 56 | A | B | 56 | A | B |
| | | Comparative Example 4 | | | | | |
| | | PLA molecular weight — | | | | | |
| | | PGA/PLA (mass ratio) PGLLA (90/10) | | | | | |
| | | Keeping conditions | | | | | |
| | | 30° C., 90% RH | | | 40° C., 90% RH | | |
| | | Tg | Releasing | Degrad- | Tg | Releasing | Degrad- |
| | | (° C.) | property | ability | (° C.) | property | ability |
| Keeping | 0 | 40 | A | A | 40 | A | A |
| time | 1 | 38 | A | A | 33 | C | A |
| (hr) | 3 | 35 | C | A | 30 | C | A |
| | 6 | 33 | C | A | 27 | C | A |
| | 18 | 25 | C | A | 23 | C | A |

TABLE 5

| | | Comparative Example 5 | | | | | | | |
|---|---|---|---|---|---|---|---|---|---|
| | | PLA molecular weight Mw = 20 × 10⁴ | | | | | | | |
| | | PGA/PLA (mass ratio) 60/40 | | | | | | | |
| | | Keeping conditions | | | | | | | |
| | | 30° C., 90% RH | | | | 40° C., 90% RH | | | |
| | | Tg^{L} | Tg^{H} | Releasing | Degrad- | Tg^{L} | Tg^{H} | Releasing | Degrad- |
| | | (° C.) | (° C.) | property | ability | (° C.) | (° C.) | property | ability |
| Keeping | 0 | 38 | 57 | A | B | 38 | 57 | A | B |
| time | 1 | 38 | 57 | A | B | 37 | 57 | A | B |
| (hr) | 3 | 38 | 57 | A | B | 36 | 57 | A | B |
| | 6 | 37 | 57 | A | B | 35 | 57 | A | B |
| | 18 | 37 | 56 | A | B | 35 | 56 | A | B |

As is apparent from the results shown in Tables 1 to 5, the Tg of the undrawn yarns obtained in Example 1 and the Tg^{L}'s of the undrawn yarns obtained in Examples 2 to 4 can be considered to be glass transition temperatures attributable to the PGA resin on the basis of the values of the temperatures. In the polyglycolic acid-based fibers of the present invention (Examples 1 to 4) obtained by blending the PGA with the PLA, having a relatively high molecular weight, the great decrease in the Tg attributable to the PGA resin with time during keeping was suppressed, and the agglutination could be successfully prevented.

Meanwhile, in the cases where the PLA having a low-molecular weight was blended (Comparative Example 1), where only the PGA was used (Comparative Example 2), and where the copolymer of glycolic acid and lactic acid was used (Comparative Example 4), the Tg greatly decreased with time during keeping, and the agglutination occurred after keeping for at least 4 hours. In addition, in the cases where only the PLA was used. (Comparative Example 3), and where the content of the PGA was 60% by mass relative to the total of the PGA and the PLA (Comparative Example 5), the decrease in the Tg with time during keeping was not observed. However, the hydrolyzability thereof was inferior to those of the polyglycolic acid-based fibers of the present invention.

### INDUSTRIAL APPLICABILITY

As described above, according to the present invention, no agglutination occurs, even when undrawn polyglycolic acid resin-based yarns obtained by melt spinning a resin composition comprising a polyglycolic acid resin are kept. Hence, the present invention makes it possible to release and draw the undrawn yarns relatively easily.

Accordingly, in the method for producing a polyglycolic acid-based fiber of the present invention, undrawn yarns comprising a polyglycolic acid resin can be easily released after keeping. Hence, the productivity of a polyglycolic acid-based fiber is improved, enabling mass production of a polyglycolic acid-based fiber. In addition, the polyglycolic acid-based fiber of the present invention maintains characteristics intrinsic to a polyglycolic acid fiber, and hence is useful as a biodegradable fiber and a special functional fiber for drilling or completion field of oil recovery and the like.

### REFERENCE SIGNS LIST

1: raw material hopper
   2: extruder
3: gear pump
4: nozzle
5: cooling tower
6: apparatus for applying oiling agent
7 to 13: first to seventh take-up rollers
14: bobbin for undrawn yaws
21: feeding roller
22: first heating roller
23: second heating roller
24: cooling roller
25: bobbin for drawn yarns

1. A method for producing a polyglycolic acid-based fiber, comprising:
a spinning process of obtaining undrawn yarns by melt spinning a polyglycolic acid-based resin composition which comprises a polyglycolic acid resin and a polylactic acid resin having a weight average molecular weight of 10×10⁴ to 30×10⁴ in a mass ratio of the polyglycolic acid resin to the polylactic acid resin of 70/30 to 99/1;
a keeping process of keeping the undrawn yarns; and
a drawing process of obtaining drawn yarns by drawing the kept undrawn yarns.

2. The method for producing a polyglycolic acid-based fiber according to claim 1, further comprising a cutting process of obtaining a staple fiber by cutting the drawn yarns.

3. The method for producing a polyglycolic acid-based fiber according to claim 1, wherein a keeping time in the keeping process is 3 hours or more.

4. A polyglycolic acid-based fiber comprising:
a polyglycolic acid resin and a polylactic acid resin having a weight average molecular weight of 10×10⁴ to 30×10⁴ in a mass ratio of the polyglycolic acid resin to the polylactic acid resin of 70/30 to 99/1.
